(19) United States
(12) Patent Application Publication
(10) Pub. No.: US 2016/0160950 A1
(43) Pub. Date: Jun. 9, 2016

(54) BRAKE PAD ASSEMBLY AND HEAT DISSIPATION STRUCTURE THEREOF

(71) Applicant: YUAN-HUNG WEN, HEMEI TOWN (TW)

(72) Inventor: YUAN-HUNG WEN, HEMEI TOWN (TW)

(21) Appl. No.: 14/864,201

(22) Filed: Sep. 24, 2015

(30) Foreign Application Priority Data
Dec. 5, 2014 (TW) 103142458

(51) Int. Cl. F16D 65/847; F16D 65/092

(52) U.S. Cl. CPC F16D 65/847; F16D 65/092; F16D 2065/789

(57) ABSTRACT

A heat dissipation structure for a brake pad is provided for being assembled to a caliper device. The caliper device includes a caliper body, and the caliper body has a receiving space. The heat dissipation structure includes: a main body, integrally extruded from aluminum and cut to have an ultimate appearance, including a plate body and a heat dissipation portion integrally extending from the plate body, the plate body for being disposed on the caliper body and at least partially extending into the receiving space, when the main body is assembled to the caliper body, the heat dissipation portion is exposed outside the caliper body. A brake pad assembly is further provided, including a heat dissipation structure as described above, further including a brake pad, the brake pad disposed on a lateral face of the plate body.

### BACKGROUND OF THE INVENTION

1. Field of the Invention

The present invention relates to a heat dissipation structure, and more particularly to a heat dissipation structure for a brake pad.

2. Description of the Prior Art

Conventionally, a heat dissipation structure for a brake pad as disclosed in TWM436108 includes a fixing board, an abrading block and at least one heat conduction tube. The fixing board is a board body and has a front side and a rear side. A connecting hole is provided near a bottom portion of the fixing board, and at least one assembling hole is formed around the connecting hole. The abrading block is fixedly disposed on the front side of the fixing board and located above the connecting hole. The at least one heat conduction tube is correspondingly fixedly connected to the at least one assembling hole of the fixing board.

However, in the above-mentioned heat dissipation structure for the brake pad, the heat conduction tube is additionally arranged on the fixing board, and the heat produced by the brake pad abraded has to transmit to the heat conduction tube via the fixing board, so the heat dissipation efficiency is unpreferable. In addition, the fixing board contacts a caliper device directly, and the fixing board may transmit the heat to the caliper device and make the caliper malfunction and decrease a service life of the heat dissipation structure for the brake pad due to rising temperature. Furthermore, members of the above-mentioned structure are complicated, so it is high-cost to manufacture and assemble the members.

The present invention has arisen to mitigate and/or obviate the afore-described disadvantages.

### SUMMARY OF THE INVENTION

The major object of the present invention is to provide a brake pad assembly and heat dissipation structure thereof. A plate body and a heat dissipation portion are integrally extruded from aluminum and cut to have an ultimate appearance, so they are easy and efficient to be manufactured. A continuous passage and a heat dissipation protrusive rib are provided for guiding air flow so that the heat produced during the braking process can be quickly dissipated through the continuously circulating air flow. A heat insulation member is further included for being arranged between the main body and a caliper device to prevent the heat from transmitting to the caliper device so as to protect the caliper device, prolong a service life of the caliper device and maintain the functional effectiveness of the caliper device.

To achieve the above and other objects, a heat dissipation structure for a brake pad is provided for being assembled to a caliper device. The caliper device includes a caliper body, and the caliper body has a receiving space. The heat dissipation structure for the brake pad includes: a main body, integrally extruded from aluminum and cut to have an ultimate appearance, including a plate body and a heat dissipation portion which integrally extends from the plate body, the plate body being provided for being assembled to the caliper body and at least partially extending into the receiving space, when the main body is assembled to the caliper body, the heat dissipation portion is exposed outside the caliper body.

To achieve the above and other objects, a brake pad assembly is further provided, including the heat dissipation structure for the brake pad described above, and further including a brake pad which is disposed on a lateral face of a plate body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a sketch of a preferred embodiment of the present invention;

FIG. 2 is a cross-sectional view of the preferred embodiment of the present invention;

FIG. 3 is a cross-sectional view of the preferred embodiment of the present invention in use;

FIG. 4 is a drawing showing an aluminum extrusion of the preferred embodiment of the present invention;

FIG. 5 is a cross-sectional view of another preferred embodiment of the present invention; and

FIG. 6 is a cross-sectional view of still another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

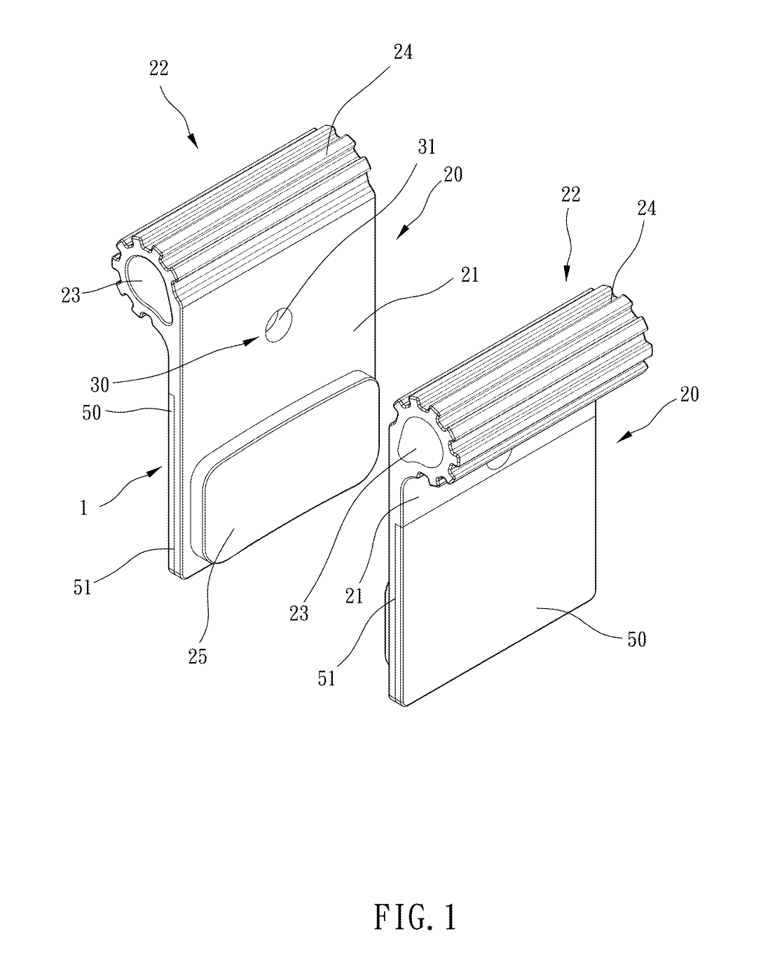

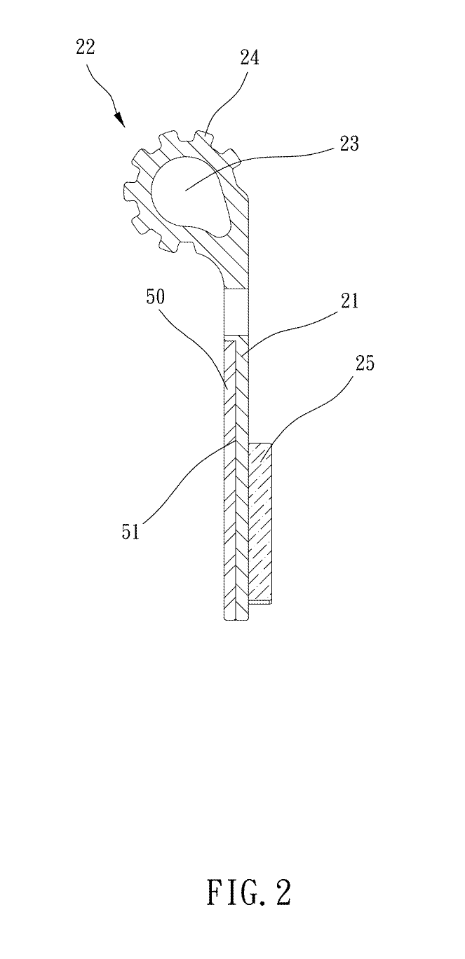

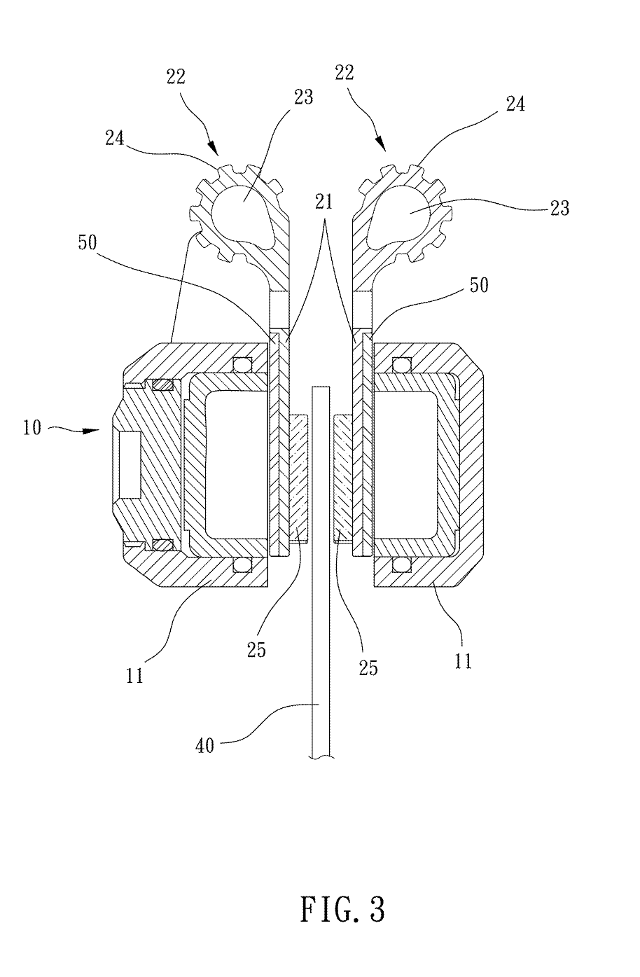

Please refer to FIGS. 1 to 4 for a preferred embodiment of the present invention. A heat dissipation structure 1 for a brake pad is provided for being assembled to a caliper device 10, and the caliper device 10 can be mounted on, for example, a bicycle. The caliper device 10 includes a caliper body 11, and the caliper body 11 has a receiving space. The heat dissipation structure 1 for the brake pad includes a main body 20, and the main body 20 includes a plate body 21 and a heat dissipation portion 22.

Specifically, the heat dissipation portion 22 integrally extends from the plate body 21, and the heat dissipation portion 22 curls outwardly relative to the plate body 21 and defines a continuous passage 23. In this embodiment, the heat dissipation portion 22 preferably curls to be substantially circularly curved; however, in other embodiments, the heat dissipation portion 22 may be folded into other shapes, for example, polygonal. Preferably, a thickness of the heat dissipation portion 22 is smaller than a thickness of the plate body 21.

In this embodiment, an end of the heat dissipation portion 22 on a curling direction in which the heat dissipation portion 22 curls is connected with the plate body 21 to form a continuous tubular structure. The heat dissipation portion 22 is formed with a plurality of protrusive ribs 24 arranged in intervals. The protrusive ribs 24 are arranged along a direction parallel to an axial direction of the continuous passage 23; however, in other embodiments, the protrusive ribs may be arranged along a direction transverse to the axial direction of the continuous passage 23.

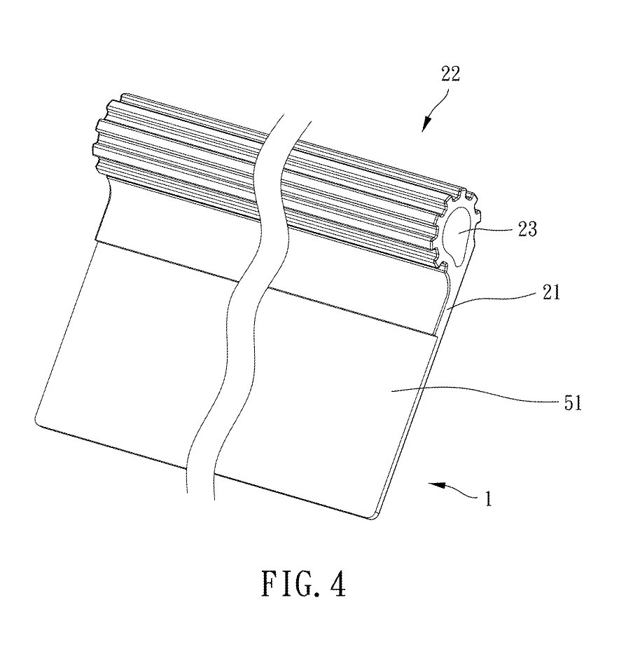

It is to be noted that the plate body 21 and the heat dissipation portion 22 are integrally extruded from aluminum and cut to have an ultimate appearance (an extruded aluminum bar as shown in FIG. 4), so they are easy and quick to be manufactured. Preferably, the extruded aluminum bar can be cut into different widths in accordance with various requirements.

In actual practice, the main body 20 has at least one assembling portion 30, and the assembling portion 30 is for being positioningly assembled to the caliper body 11. The assembling portion 30 may include a through hole 31, and the main body 20 may be disposed through the through hole 31 via a screw member to be fixedly screwed with the caliper body 11. The plate body 21 is assembled to the caliper body 11 and at least partially extends into the receiving space, and when the main body 20 is assembled to the caliper body 11, the heat dissipation portion 22 is exposed outside the caliper body 11.

When a vehicle is driven, the continuous passage 23 faces an air flow, and the continuous passage 23 is for guiding the air flow to flow through the continuous passage 23 continuously. When the caliper device 10 is driven to brake the vehicle (the caliper device 10 receives an external force, for example, a pushing force from the hydraulic system, and a piston of the caliper body 11 pushes the main body 20 to actuate a brake pad 25 assembled to the main body 20 to frictionally contact a disk 40 of the vehicle to brake), the heat produced during an abrading process can be quickly dissipated via the air flow flowing through the continuous passage 23 continuously. It is to be noted that the protrusive ribs 24 formed on the heat dissipation portion 22 can increase dissipation surface of the heat dissipation portion 22 to air so that the heat dissipation efficiency is elevated to produce preferable heat dissipation effect.

More specifically, a side of the plate body 21 may be further provided with a heat insulation member 50, and the heat insulation member 50 is arranged between the plate body 21 and the caliper body 11. For example, the plate body 21 may include a recessed slot 51, and the heat insulation member 50 is engaged in the recessed slot 51. In use, the heat insulation member 50 can decrease an amount of the heat which is produced by the main body 20 during the braking process transmitting to the caliper body 11. The heat insulation member 50 may be a board which is made of titanium alloy, plastic steel or ceramic material, so the heat insulation member 50 has a lower thermal conductivity than that of the main body 20; therefore, the caliper body 11 can be prevented from malfunctioning due to rising temperature, and the caliper device can be protected to prolong a service life and to maintain functional effectiveness.

A brake pad assembly is further provided, including a heat dissipation structure 1 for a brake pad described above and a brake pad 25. The brake pad 25 is arranged on a lateral face of the plate body 21, and the brake pad assembly may be assembled to a caliper device of the vehicle. During the braking process, the brake pad assembly can dissipate heat quickly to prevent the brake pad 25 from malfunctioning due to overheating and to decrease the amount of heat transmitting to the caliper device.

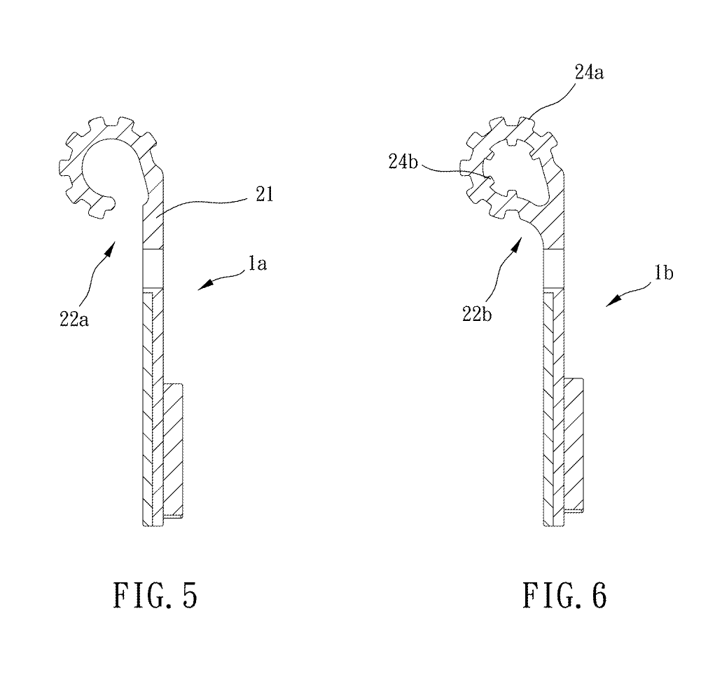

Please refer to another embodiment as shown in FIG. 5. A distal end of a heat dissipation portion 22a of a heat dissipation structure 1a for a brake pad on the curling direction in which the heat dissipation portion 22a curls may be a free end. Specifically, an end of the heat dissipation portion 22a on the curling direction in which the heat dissipation portion 22a curls may be unconnected with the plate body 21 to form a notch for air circulation and heat dissipation.

Please refer to still another embodiment as shown in FIG. 6. An inner surface and an outer surface of a heat dissipation portion 22b of a heat dissipation structure 1b for a brake pad are respectively formed with a plurality of protrusive ribs 24a, 24b to increase heat dissipation area and elevate heat dissipation effectiveness.

Given the above, in the brake pad assembly and the heat dissipation structure thereof, the plate body and the heat dissipation portion are integrally extruded from aluminum and cut to have an ultimate appearance; therefore, it is easy, quick and low-cost to manufacture the brake pad assembly and the heat dissipation structure thereof.

In addition, the continuous passage for guiding air flow and the protrusive ribs are provided, so the heat produced during the braking process can be quickly dissipated through the continuously circulating air flow.

Furthermore, the heat insulation member arranged between the main body and the caliper device is provided to prevent the heat from transmitting to the caliper device, protect the caliper device, prolong the service life of the caliper device and maintain the functional effectiveness of the caliper device.

While we have shown and described various embodiments in accordance with the present invention, it should be clear to those skilled in the art that further embodiments may be made without departing from the scope of the present invention.

What is claimed is:

1. A heat dissipation structure for a brake pad, provided for being assembled to a caliper device, the caliper device including a caliper body, the caliper body having a receiving space, the heat dissipation structure including:
a main body, integrally extruded from aluminum and cut to have an ultimate appearance, including a plate body and a heat dissipation portion which integrally extends from the plate body, the plate body being provided for being assembled to the caliper body and at least partially extending into the receiving space, when the main body is assembled to the caliper body, the heat dissipation portion is exposed outside the caliper body.

2. The heat dissipation structure for the brake pad of claim 1, wherein the heat dissipation portion curls outwardly relative to the plate body and defines a continuous passage.

3. The heat dissipation structure for the brake pad of claim 2, wherein the heat dissipation portion is formed with a plurality of protrusive ribs arranged in intervals.

4. The heat dissipation structure for the brake pad of claim 3, wherein an inner surface and an outer surface of the heat dissipation portion are respectively formed with a plurality of protrusive ribs arranged in intervals.

5. The heat dissipation structure for the brake pad of claim 1, wherein a side of the plate body is provided with a heat insulation member, and the heat insulation member is arranged between the plate body and the caliper body.

6. The heat dissipation structure for the brake pad of claim 5, wherein the heat insulation member is a board made of titanium alloy, plastic steel or ceramic material.

7. The heat dissipation structure for the brake pad of claim 1, wherein the main body is formed with at least one assembling portion, and the assembling portion is for being positioningly assembled to the caliper body.

8. The heat dissipation structure for the brake pad of claim 2, wherein a distal end of the heat dissipation portion on a curling direction in which the heat dissipation portion curls is a free end.

9. The heat dissipation structure for the brake pad of claim 2, wherein an end of the heat dissipation portion on a curling direction in which the heat dissipation portion curls is connected with the plate body and forms a continuous tubular structure.

10. A brake pad assembly, including a heat dissipation structure for a brake pad of claim 1, further including a brake pad which is disposed on a lateral face of the plate body.
